(19) United States
(12) Patent Application Publication
(10) Pub. No.: US 2016/0061101 A1
(43) Pub. Date: Mar. 3, 2016

(54) ENGINE SYSTEM INCLUDING TURBOCHARGER AND SUPERCHARGER

(71) Applicant: HYUNDAI MOTOR COMPANY, Seoul (KR)

(72) Inventors: Kihoon NAM, Gunpo-si (KR); JongMan JUN, Hwaseong-si (KR)

(21) Appl. No.: 14/835,346

(22) Filed: Aug. 25, 2015

(30) Foreign Application Priority Data
Aug. 28, 2014 (KR) 10-2014-0113205

(51) Int. Cl. F02B 37/04; F02B 39/12; F02B 39/00; F02M 35/10; F01N 3/20; F02B 33/40; F02M 25/07

(52) U.S. Cl. CPC F02B 37/04; F02B 33/40; F02B 39/12; F02M 25/0711; F02M 35/10157; F01N 3/20; F02B 39/005

(57) ABSTRACT

An engine system, that includes a turbocharger and a supercharger, forms a boost pressure in an intake with the turbocharger, complements an insufficient boost pressure with the supercharger and supplies an exhaust gas from an exhaust line to an intake line.

### CROSS-REFERENCE TO RELATED APPLICATION

This application claims the benefit of priority to Korean Patent Application No. 10-2014-0113205, filed in the Korean Intellectual Property Office on Aug. 28, 2014, the entire contents of which are incorporated herein by reference.

### TECHNICAL FIELD

The present disclosure relates to an engine system including a turbocharger and a supercharger. More particularly, the present disclosure relates to an engine system including a turbocharger and a supercharger that forms a boost pressure of an intake with the turbocharger, complements an insufficient boost pressure with the supercharger, and supplies an exhaust gas from an exhaust line to an intake line.

### BACKGROUND

After introducing external air, a vehicle mixes the air with a fuel to supply the mixture to an engine. The engine combusts the mixture of the fuel and the air to obtain power necessary to drive the vehicle.

During operation of the engine, the external air must be sufficiently supplied for combustion for a desired output of the engine. Accordingly, in order to improve the output of the engine, a turbocharger for supplying combustion air by pressurizing the combustion air may be applied to the vehicle.

In order to reduce fuel consumption, use of the turbocharger has increased and has been applied to gasoline engines, as well as diesel engines.

The turbocharger is applied to a gasoline engine to generate high torque with a small amount of exhaust, and to significantly improve high speed and grade ability. However, vehicle drivability may be negatively impacted due to turbocharger lag occurring during low speed acceleration.

In order to prevent the above turbocharger lag, and to improve acceleration responsiveness, a supercharger for driving a compressor using power from an engine to compress and supply intake air may be applied to the vehicle.

In the vehicle to which the turbocharger and the supercharger are applied, a low pressure exhaust gas recirculation (LP-EGR) system may be applied to the vehicle so a boost pressure can be maintained.

However, boost pressure may be increased by operation of the turbocharger and the supercharger, and exhaust gas may not be sufficiently recirculated.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to provide an engine system including a turbocharger and a supercharger forming a boost pressure of an intake with the turbocharger, complementing an insufficient boost pressure with the supercharger, and supplying an exhaust gas from an exhaust line to an intake line.

An exemplary embodiment of the present disclosure provides an engine system including a turbocharger and a supercharger that may include: a first intake line for drawing external air; a second intake line formed separately from the first intake line for drawing the external air; a main intake line to which the first intake line and the second intake line are joined and that is connected to an intake manifold of the engine; an exhaust line connected to an exhaust manifold of the engine and discharging exhaust gasses of the engine to the outside; a turbocharger including a turbine rotated by exhaust gasses passing through the exhaust line and a compressor disposed at the first intake line, rotated by the turbine, compressing intake air by the turbine, and transmitting intake air to the main intake line; and a supercharger disposed at the second intake line that compresses intake air by being selectively operated according to a driving condition, and transmitting the intake air to the main intake line.

The engine system may further include: an intercooler disposed at the main intake line to cool external air passing therethrough; a high pressure exhaust gas recirculation line branched from an upstream side of the turbine of the turbocharger and joined to a downstream side of the intercooler to recirculate exhaust gasses; a high pressure exhaust gas recirculation cooler disposed at the high pressure exhaust gas recirculation line to cool recirculated exhaust gasses; and a high pressure exhaust gas recirculation valve which controls recirculated exhaust gasses passing through the high pressure exhaust gas recirculation line.

The engine system may further include: a catalyst unit disposed at the downstream side of the turbocharger and purifies exhaust gas passing therethrouch; a low pressure exhaust gas recirculation line branched from a downstream side of the catalyst unit and joined to the first intake line connected to an upstream side of the compressor of the turbocharger to recirculate exhaust gasses; a low pressure exhaust gas recirculation cooler disposed at the low pressure exhaust gas recirculation line to cool recirculated exhaust gasses; and a low pressure exhaust gas recirculation valve which controls recirculated exhaust gas passing through the low pressure exhaust gas recirculation line.

The engine system may further include a clutch which selectively transmits a torque of a crankshaft of the engine to the supercharger; and a controller which controls the clutch according to the driving condition of the vehicle.

The engine system may further include a controller which controls a motor according to the driving condition of the vehicle, wherein the supercharger is selectively operated by the motor.

The controller may turn off the supercharger and recirculate exhaust gasses through the low pressure exhaust gas recirculation line when the driving condition is a constant speed condition.

The controller may turn on the supercharger and recirculate exhaust gasses through the low pressure exhaust gas recirculation line when the driving condition is a gentle acceleration condition.

The controller may turn on the supercharger and not recirculate exhaust gasses through the low pressure exhaust gas recirculation line when the driving condition is a rapid acceleration condition.

The controller may turn off the supercharger upon detecting a pressure supplied to the intake manifold from the main intake line when a target boost pressure is greater than a predetermined pressure.

As described above, the engine system to which a turbocharger and a supercharger are applied according to an exemplary of the present disclosure can complement a boost pressure by operating the supercharger.

In addition, exhaust gasses can be recirculated through a high pressure exhaust gas recirculation line and a low pressure exhaust gas recirculation line, so fuel consumption and quality of exhaust gasses may be improved.

### BRIEF DESCRIPTION OF THE DRAWINGS

FIG. 1 is a schematic diagram of an engine system including a turbocharger and a supercharger according to an exemplary embodiment of the present disclosure.

FIG. 2 is a flowchart showing a control method of an engine system including a turbocharger and a supercharger according to an exemplary embodiment of the present disclosure.

FIG. 3 is a flowchart showing a control method of an engine system including a turbocharger and a supercharger according to another exemplary embodiment of the present disclosure.

### DETAILED DESCRIPTION

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure.

Throughout this specification and the claims which follow, unless explicitly described to the contrary, the word “comprise” and variations such as “comprises” or “comprising” will be understood to imply the inclusion of stated elements but not the exclusion of any other elements.

Like reference numerals designate like elements throughout the specification.

It is understood that some of the methods may be executed by at least one controller. The term “controller” refers to a hardware device that includes a memory and a processor configured to execute one or more steps that should be interpreted as its algorithmic structure. The memory is configured to store algorithmic steps, and the processor is specifically configured to execute said algorithmic steps to perform one or more processes which are described further below.

Furthermore, the control logic of the present disclosure may be embodied as non-transitory computer readable media on a computer readable medium containing executable program instructions executed by a processor, a controller, or the like. Examples of computer readable media include, but are not limited to, ROM, RAM, compact disc (CD)-ROM, magnetic tapes, floppy disks, flash drives, smart cards, and optical data storage devices. The computer readable recording medium can also be distributed in network coupled computer systems so that the computer readable media is stored and executed in a distributed fashion, e.g., by a telematics server or a controller area network (CAN).

An exemplary embodiment of the present disclosure will hereinafter be described in detail with reference to the accompanying drawings.

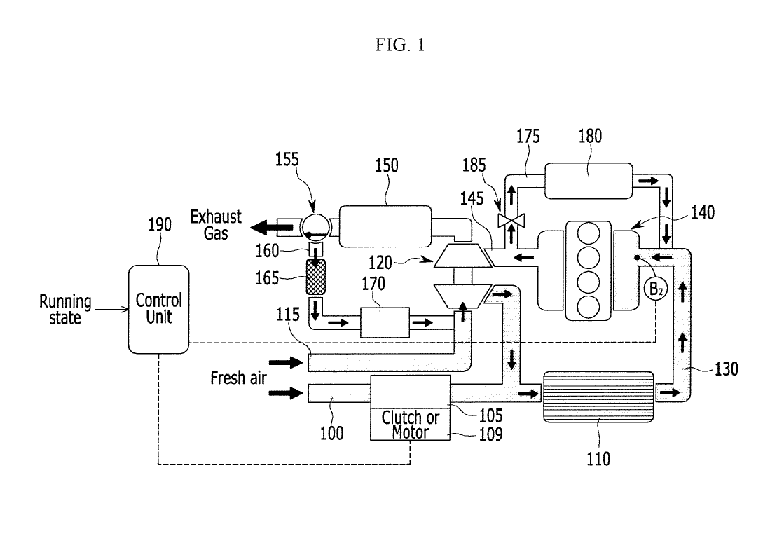

FIG. 1 is a schematic diagram of an engine system including a turbocharger and a supercharger according to an exemplary embodiment of the present disclosure.

As shown in FIG. 1, an engine system including a turbocharger and a supercharger according to an exemplary embodiment of the present disclosure may include a first intake line 115, a second intake line 100, a main intake line 130, an engine 140, an exhaust line 145, a high pressure exhaust gas recirculation line 175, a low pressure exhaust gas recirculation line 160, a supercharger 105, a clutch 109, an intercooler 110, a pressure sensor 132, a turbocharger 120, a catalyst unit 150, a high pressure exhaust gas recirculation valve 185, a high pressure exhaust gas recirculation cooler 180, a low pressure exhaust gas recirculation valve 155, an emergency filter 165, a low pressure exhaust gas recirculation cooler 170 and a controller 190.

The first intake line 115 and the second intake line 100 are formed to be distanced from each other and joined to the main intake line 130. The first intake line 115 and the second intake line 100 draw external air and transmit the external air to the main intake line 130.

Intake air supplied to the engine 140 from the main intake line 130 is combusted with fuel, and exhaust gasses are discharged through the exhaust line 145.

The turbocharger 120 includes a turbine and a compressor, and compresses intake air passing through the first intake line 115. The turbine of the turbocharger 120 may be disposed at the exhaust line 145, and the compressor of the turbocharger 120 may be disposed at the first intake line 115.

The supercharger 105 may be disposed at the second intake line 100 and selectively operated by a torque transmitted from a crankshaft of the engine 140. The clutch 109 selectively transmits torque to the supercharger 105.

In an exemplary embodiment of the present disclosure, the supercharger may be selectively operated by a motor (not shown).

The intercooler 110 may be disposed at the main intake line 130 to cool external air compressed by the turbocharger 120 or supercharger 105. The pressure sensor 132 may be disposed at the intake manifold of the engine 140 to detect a pressure of intake air.

The high pressure exhaust gas recirculation line 175 is branched from the exhaust line 145 disposed between an upstream side the turbine of the turbocharger 120 and the engine 140, and is joined to the main intake line 130. Furthermore, the high pressure exhaust gas recirculation valve 185 and the high pressure exhaust gas recirculation cooler 180 are disposed at the high pressure exhaust gas recirculation line 175.

In the exemplary embodiment of the present disclosure, the high pressure exhaust gas recirculation line 175 may be branched from an exhaust manifold of the engine.

The catalyst unit 150 is disposed at a downstream side of the turbine of the turbocharger 120. The low pressure exhaust gas recirculation line 160 is branched from a downstream side of the catalyst unit disposed at the exhaust line 145, and is joined to the first intake line 115 connected to an upstream side of the compressor of the turbocharger 120.

The low pressure exhaust gas recirculation valve 155, the emergency filter 165, and the low pressure exhaust gas recirculation cooler 170 may be disposed at the low pressure exhaust gas recirculation line 160.

The high pressure exhaust gas recirculation cooler 180 and the low pressure exhaust gas recirculation cooler 170 cool exhaust gasses and recirculate exhaust gasses toward the intake of the engine 140. An opening of the high pressure exhaust gas recirculation valve 185 and the low pressure exhaust gas recirculation valve 155 may be controlled by the controller 190.

The controller 190 controls an operation of the supercharger 105 through the clutch 109, the low pressure exhaust gas recirculation valve 155, and the high pressure exhaust gas recirculation valve 185 according to a driving condition of the vehicle.

In addition, the controller 190 may determine the driving condition as one of a constant speed condition, a gentle acceleration condition, and/or a rapid acceleration condition by detecting a position value of an accelerator pedal.

In the exemplary embodiment of the present disclosure, a motor is disposed beside the supercharger 105 instead of the clutch 109, and the controller 190 controls an operation of the motor.

The controller 190 may be implemented as at least one processor operated by a predetermined program, and the predetermined program may be programmed in order to perform each step of a control method of an engine system including a turbocharger and a supercharger according to an exemplary embodiment of the present disclosure to be described below.

In the exemplary embodiment of the present disclosure, the low pressure exhaust gas recirculation line 160 may supply exhaust gasses to the upstream side of the compressor of the turbocharger 120 from the downstream side of the catalyst unit 150.

Therefore, when a boost pressure is low, the supercharger 105 may increase the boost pressure, and improve power performance and responsiveness.

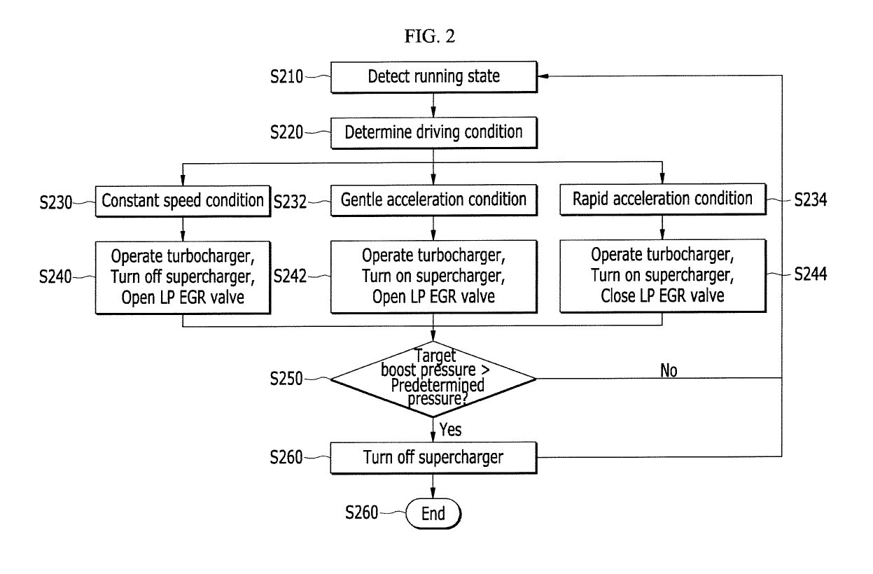

FIG. 2 is a flowchart showing a control method of an engine system including a turbocharger and a supercharger according to an exemplary embodiment of the present disclosure.

As shown in FIG. 2, a control method of an engine system including a turbocharger and a supercharger according to an exemplary embodiment of the present disclosure may start with detecting a running state of the vehicle at step S210. The running state may include a vehicle speed, an engine rotation speed, a fuel injection amount, a load of the vehicle, a position value of an accelerator pedal and a change rate of a position value of an accelerator pedal.

When the running state of the vehicle is detected at step S210, the controller 190 determines a driving condition of the vehicle at step S220. The driving condition of the vehicle may include a constant speed condition, a gentle acceleration condition and/or a rapid acceleration condition.

The controller 190 may determine the driving condition of the vehicle according to the position value of the accelerator pedal. For example, when the position value of the accelerator pedal is less than than 10%, the driving condition is determined as the constant speed condition. When the position value of the accelerator is greater than or equal to 10% and less than 40%, the driving condition is determined as the gentle acceleration condition. When the position value of the accelerator is greater than or equal to 40%, the driving condition is determined as the rapid acceleration condition.

The controller 190 performs step S240 when the driving condition is the constant speed condition, the controller 190 performs step S242 when the driving condition is the gentle acceleration condition, and the controller 190 performs step S244 when the driving condition is the rapid acceleration condition.

The controller 190 operates the turbocharger 120, turns off the supercharger 105, and opens the low pressure exhaust gas recirculation valve 155 to recirculate exhaust gas at step S240.

The turbocharger 120 may be operated in various ways. For example, the turbocharger 120 may be operated according to an amount of exhaust gas depending on an opening of a waste gate valve or a bypass valve.

The controller 190 operates the turbocharger 120, turns on the supercharger 105, and opens the low pressure exhaust gas recirculation valve 155 to recirculate exhaust gas at step S242.

The controller 190 operates the turbocharger 120, turns on the supercharger 105, and closes the low pressure exhaust gas recirculation valve 155 to not recirculate exhaust gas at step S244.

The controller 190 determines whether a target boost pressure is greater than a predetermined pressure by detecting a pressure supplied to the intake manifold through the pressure sensor 132 at step S250. When the target boost pressure is less than or equal to the predetermined pressure, the controller 190 returns to step S210. On the other hand, when the target boost pressure is greater than the predetermined pressure, the controller 190 performs step S260 that turns off the supercharger 105.

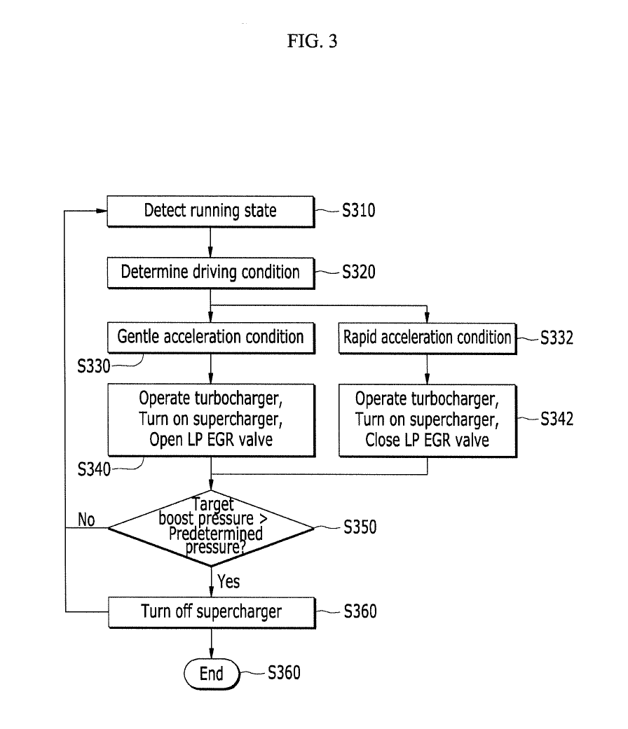

FIG. 3 is a flowchart showing a control method of an engine system including a turbocharger and a supercharger according to another exemplary embodiment of the present disclosure.

As shown in FIG. 3, a control method of an engine system including a turbocharger and a supercharger according to another exemplary embodiment of the present disclosure may start with detecting a running state of the vehicle at step S310. The running state may include a vehicle speed, an engine rotation speed, a fuel injection amount, a load of the vehicle, a position value of an accelerator pedal and a change rate of a position value of an accelerator pedal.

When the running state of the vehicle is detected at step S310, the controller 190 determines a driving condition of the vehicle at step S320.

The driving condition of the vehicle may be determined as a gentle acceleration condition or a rapid acceleration condition according to a position value of an accelerator pedal. That is, when the position value of the accelerator is less than 40%, the driving condition is determined as the gentle acceleration condition, and when the position value of the accelerator is greater than or equal to 40%, the driving condition is determined as the rapid acceleration condition.

When the driving condition is determined at the step S320, the controller 190 performs step S340 when the driving condition is the gentle acceleration condition, and the controller 190 performs step S342 when the driving condition is the rapid acceleration condition.

The controller 190 operates the turbocharger 120, turns on the supercharger 105, and opens the low pressure exhaust gas recirculation valve 155 to recirculate exhaust gas at step S340.

The controller 190 operates the turbocharger 120, turns on the supercharger 105, and closes the low pressure exhaust gas recirculation valve 155 to not recirculate exhaust gas at step S342.

The controller 190 determines whether a target boost pressure is greater than a predetermined pressure at step S350. When the target boost pressure is less than or equal to the predetermined pressure, the controller 190 returns the step S310. On the other hand, when the target boost pressure is greater than the predetermined pressure, the controller 190 performs step S360 that turns off the supercharger 105.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

What is claimed is:

1. An engine system including a turbocharger and a supercharger, comprising:
a first intake line for drawing external air;
a second intake line for drawing external air formed separately from the first intake line;
a main intake line to which the first intake line and the second intake line are joined, and the main intake line connected to an intake manifold of an engine;
an exhaust line connected to an exhaust manifold of the engine, and the exhaust line discharging exhaust gasses of the engine to the outside;
a turbocharger including a turbine rotated by exhaust gasses passing through the exhaust line and a compressor disposed at the first intake line, wherein the compressor is rotated by the turbine, compresses intake air, and transmits the intake air to the main intake line; and
a supercharger disposed at the second intake line, wherein the supercharger compresses intake air, transmits the intake air to the main intake line, and is selectively operated according to a driving condition.

2. The engine system of claim 1, further comprising:
an intercooler disposed at the main intake line for cooling external air passing therethrough;
a high pressure exhaust gas recirculation line branched from an upstream side of the turbine of the turbocharger and joined to a downstream side of the intercooler to recirculate exhaust gasses;
a high pressure exhaust gas recirculation cooler which is disposed at the high pressure exhaust gasses recirculation line to cool recirculated exhaust gasses; and
a high pressure exhaust gas recirculation valve controlling recirculated exhaust gasses passing through the high pressure exhaust gas recirculation line.

3. The engine system of claim 1, further comprising:
a catalyst unit disposed at the downstream side of the turbocharger for purifying exhaust gasses passing therethrough;
a low pressure exhaust gas recirculation line branched from a downstream side of the catalyst unit and joined to the first intake line connected to an upstream side of the compressor of the turbocharger to recirculate exhaust gasses;
a low pressure exhaust gas recirculation cooler disposed at the low pressure exhaust gas recirculation line for cooling recirculated exhaust gasses; and
a low pressure exhaust gas recirculation valve which controls recirculated exhaust gasses passing through the low pressure exhaust gas recirculation line.

4. The engine system of claim 3, further comprising:
a clutch which selectively transmits a torque of a crankshaft of the engine to the supercharger; and
a controller which controls the clutch according to the driving condition of the vehicle.

5. The engine system of claim 4, wherein the controller turns off the supercharger and recirculates exhaust gasses through the low pressure exhaust gas recirculation line when the driving condition is a constant speed condition.

6. The engine system of claim 4, wherein the controller turns on the supercharger and recirculates exhaust gasses through the low pressure exhaust gas recirculation line when the driving condition is a gentle acceleration condition.

7. The engine system of claim 4, wherein the controller turns on the supercharger and does not recirculate exhaust gasses through the low pressure exhaust gas recirculation line when the driving condition is a rapid acceleration condition.

8. The engine system of claim 4, wherein the controller turns off the supercharger upon detecting a pressure supplied to the intake manifold from the main intake line when a target boost pressure is greater than a predetermined pressure.

9. The engine system of claim 1, further comprising a controller which controls a motor according to the driving condition of the vehicle,
wherein the supercharger is selectively operated by the motor.

10. The engine system of claim 9, wherein the controller turns off the supercharger and recirculates exhaust gasses through the low pressure exhaust gas recirculation line when the driving condition is a constant speed condition.

11. The engine system of claim 9, wherein the controller turns on the supercharger and recirculates exhaust gasses through the low pressure exhaust gas recirculation line when the driving condition is a gentle acceleration condition.

12. The engine system of claim 9, wherein the controller turns on the supercharger and does not recirculate exhaust gasses through the low pressure exhaust gas recirculation line when the driving condition is a rapid acceleration condition.

13. The engine system of claim 9, wherein the controller turns off the supercharger upon detecting a pressure supplied to the intake manifold from the main intake line when a target boost pressure is greater than a predetermined pressure.
